(19) United States
(12) Patent Application Publication
(10) Pub. No.: US 2020/0235447 A1
(43) Pub. Date: Jul. 23, 2020

(54) ENERGY STORAGE ASSEMBLY

(71) Applicant: Mahle International GmbH, Stuttgart (DE)

(72) Inventors: Stefan Hirsch, Stuttgart (DE); Michael Moser, Ellwangen (DE); Mario Wallisch, Aichtal (DE); Caroline Janzen, Stuttgart (DE)

(21) Appl. No.: 16/634,044

(22) PCT Filed: Jun. 11, 2018
(86) PCT No.: PCT/EP2018/065351

§ 371 Date: Jan. 24, 2020

(30) Foreign Application Priority Data
Jul. 25, 2017 (DE) 10 2017 212 745.7

(51) Int. Cl. H01M 10/6555; H01M 2/10; H01M 10/613; H01M 10/625; H01M 10/647

(52) U.S. Cl. CPC H01M 10/6555; H01M 2/1077; H01M 2220/20; H01M 10/625; H01M 10/647; H01M 10/613

(57) ABSTRACT

An energy storage assembly may include at least one energy storage module having multiple heat conduction plates, which may be arranged parallel to one another, a receiving pocket being formed between each set of two adjacent heat conduction plates. In each receiving pocket, an energy storage element may be arranged lying against the receptive heat conduction plates. The multiple heat conduction plates may be arranged perpendicularly at least on one side on an areal cooling assembly. The areal cooling assembly may include at least one cooling tube through which a coolant may be flowable, and the respective heat conduction plate may be fixed to the at least one cooling tube in a material-bonded manner.

### CROSS-REFERENCE TO RELATED APPLICATIONS

This application claims priority to International Patent Application No. PCT/EP2018/0653351, filed on Jun. 11, 2018, and German Patent Application No. DE 10 2017 212 745.7, filed on Jul. 25, 2017, the contents of both of which are hereby incorporated by reference in their entirety.

### TECHNICAL FIELD

The invention relates to an energy storage assembly having at least one energy storage module and a method for producing the energy storage assembly.

### BACKGROUND

A traction battery is used in an electric or in a hybrid vehicle in order to supply an electric drive with energy. The traction battery comprises multiple battery modules in which individual battery cells are interconnected in parallel or in series to form the respective battery module. During the current generation, heat is generated in the battery modules which has to be dissipated. In particular, the individual battery cells in the battery module have to be adequately cooled. For this purpose, the individual battery cells are arranged between heat-discharging and usually metallic plates, so that the battery module substantially is one that alternates between the battery cells and the heat-discharging plate. For cooling the battery module and the individual battery cells, the heat-discharging plates are fixed to a cooling plate through which a coolant can flow in a force-fitting or material-bonded manner. Traction batteries with such battery modules are known for example from DE 2012 101 141 A1 and EP 2 200 109 B1.

In the case of the heat-discharging plates fixed to the cooling plate, additional heat-conductive interface materials—for example pastes or films—have to be arranged between the heat-discharging plates and the cooling plate for reducing the thermal resistance. Since compared with the heat-discharging plates, the interface materials have a multiple times higher thermal resistance, the individual battery cells in the battery module cannot be adequately cooled. Furthermore, the production expenditure and the total costs of the battery module are increased because of this. In the case of the heat-discharging plates fixed to the cooling plate in a material-bonded manner, the stack of the battery module has a greater stiffness so that during a heat expansion of the battery cells irreparable damage can be caused in the battery module.

### SUMMARY

The object of the invention therefore is to provide an energy storage assembly and a method for producing the energy storage assembly with which the mentioned disadvantages are overcome.

According to the invention, this object is solved through the subject of the independent claims. Advantageous embodiments are subject of the dependent claims.

The present invention is based on the general idea of achieving a better cooling without increasing the stiffness of the energy storage module in an energy storage assembly having at least one energy storage module. The at least one energy storage module comprises multiple heat conduction plates, wherein the respective heat conduction plates are arranged parallel to one another and a receiving pocket is formed between the respective two heat conduction plates. In the respective receiving pocket, an energy storage element each is arranged lying against the respective heat conduction plates on both sides and the multiple heat conduction plates are arranged perpendicularly on an areal cooling assembly. According to the invention, the cooling assembly comprises at least one cooling tube through which a coolant can flow and the respective heat conduction plate is fixed at least on one side to the at least one cooling tube in a material-bonded manner.

By fixing the respective heat conduction plate to the at least one cooling tube of the cooling assembly in a material-bonded manner, the cooling of the heat conduction plates and consequently of the respective energy storage elements arranged in the receiving pockets between the heat conduction plates can be improved. Compared with a cooling plate, the at least one cooling tube can be elastically deformed perpendicularly to its longitudinal axis, so that during a heat expansion of the energy storage elements, irreparable damage in the energy module is avoided. Here, the cooling assembly can be soldered and prefabricated for example from aluminium and comprise both a cooling tube and also multiple stamped or extruded cooling tubes. In order to better cool the energy storage module it is provided, furthermore, that the heat conduction plates are each fixed to both sides to at least one cooling tube of the cooling assembly in a material-bonded manner.

A material-bonded connection is present when the connecting partners are held together through nuclear or molecular forces. Material-bonded connections are non-detachable connections at the same time insofar as these connections can only be separated by destroying the connecting means. Material-bonded connections are in particular soldered connections, welded connections, glued connections and vulcanisation connections. The mentioned connection means are then the soldering means, welding means, adhesives and vulcanisation materials which are likewise employed in the process.

In a further development of the solution according to the invention it is provided that the respective heat conduction plate is fixed to the at least one cooling tube in a material-bonded manner by a laser welding. By way of the laser welding, a material-bonded connection of the respective heat conduction plate to the at least one cooling tube can be established with reduced expenditure. Because of this, the production costs of the energy storage assembly are reduced on the one hand and a secure and durable fixing of the heat conduction plates without increasing the thermal resistance between the respective heat conduction plate and the at least one cooling tube of the cooling assembly is made possible on the other hand.

Here it is advantageously provided that a thickness of the respective heat conduction plate, at least in a material-bonded region, corresponds to a thickness of the corresponding cooling tube. The material-bonded region is defined as a region on the at least one cooling tube on which the respective heat conduction plate is fixed in a material-bonded manner. Appropriately, the material-bonded region extends along the longitudinal axis of the at least one cooling tube over the entire width of the respective heat conduction plate fixed to the at least one cooling tube in a material-bonded manner.

In order to make possible a position-secure arranging of the respective heat conduction plate on the at least one cooling tube it is advantageously provided that the respective heat conduction plate comprises a stop offset facing the cooling assembly, which on the at least one cooling tube forms a stop for the respective heat conduction plate. Through the stop offset, the respective heat conduction plate is arranged on the cooling tube in a position-secure manner and fixed to the same in a material-bonded manner. In addition, the stop offset can protect the energy storage elements during the material-bonded fixing. In particular, the stop offset during the laser welding prevents the laser beam impinging on the respective energy storage element and thus also it being damaged. Alternatively or additionally, the respective energy storage element can also comprise a plastic casing. Preferably, the plastic casing is produced by over moulding the respective energy storage element. The plastic casing can appropriately encase the energy storage element, protecting the same from damage. In particular, the plastic casing can advantageously prevent the laser beam impinging on the energy storage element during the laser welding.

Advantageously, the respective heat conduction plate has a high heat conductivity and consists of aluminium or of an aluminium alloy or of graphite or of graphene or of a heat-conductive composite material. Here, the heat conduction plates can have both an isotropic and also an anisotropic heat conductivity. With a heat conduction plate configured in such a manner, the heat generated in the energy storage elements can be better conducted to the cooling assembly and dissipated.

In a particularly preferred configuration of the energy storage assembly according to the invention it is provided that the respective energy storage element comprises two energy storage units which are separated from one another by a plate-shaped spring element. The two energy storage units consequently lie each on one side against one of the heat conduction plates and on the other side against the plate-shaped spring element. The heat generated in the energy storage units is consequently conducted and discharged to the cooling assembly through the unilaterally abutting heat conduction plates. Through the plate-shaped spring element, the respective energy storage unit lies against the respective heat conduction plate over the full surface area and the thermal resistance between the respective energy storage unit and the respective heat conduction plate is reduced. Because of this, the heat generated in the energy storage units can be better discharged to the heat conduction plates. Appropriately the plate-shaped spring element is permanently elastic so that the manufacturing tolerances and the tolerances created through the heat expansion of the heat conduction plates and of the energy storage units are balanced even after multiple temperature fluctuations.

In order to fix the spring element in the energy storage element, it is advantageously provided that the spring element on both sides has an adhesive coat each, through which the spring element is fixed to both sides to the respective energy storage units in a material-bonded manner. The bonding layer can be for example an adhesive coat, which makes possible a durable fixing of the spring element in the energy storage element and prevents the spring element on the energy units being dislocated.

Advantageously it is provided, furthermore, that the energy storage element comprises at least one electrically insulating coating which is arranged between the respective heat conduction plate and the respective energy storage unit. The coating is electrically insulating and can be provided in particular with the electrically conductive heat conduction plates in order to prevent a current leakage from the energy storage unit into the respective heat conduction plate and to the cooling assembly. The coating can be for example a thin plastic film through which the energy storage unit is electrically insulated from the respective heat conduction plate. Alternatively, the electrically insulating coating can also be a lamination which is applied to the heat conduction plate and/or to the respective energy storage unit in a coating method. Advantageously, the coating can also be an adhesive coat with electrically insulating characteristics through which the respective energy storage unit is electrically insulated from the respective heat conduction plate and additionally fixed to the respective heat conduction plate.

In order to be able to fix the energy storage unit to the respective heat conduction plate it is provided that the electrically insulating coating on both sides has a bonding layer each through which the electrically insulating coating is fixed to the respective energy storage unit and to the respective heat conduction plate in a material-bonded manner. The bonding layer can be for example an adhesive coat through which the electrically insulating coating—and in particular a coating in the form of a plastic film—can be fixed to the respective energy storage unit and the respective heat conduction plate. Through the bonding layers on the electrically insulating coating, energy storage unit and the entire energy storage element are also fixed in the receiving pocket formed through the adjacent heat conduction plates and an undesirable dislocating of the energy storage element in the receiving pocket advantageously prevented.

In an advantageous further development of the energy storage assembly according to the invention it is provided that the at least one energy storage module comprises a clamping device through which a stack formed by the heat conduction plate and the energy storage elements is clamped in the stack direction. In the stack clamped in the stack direction, the heat conduction plates have a defined distance relative to one another and the energy storage elements lying against the heat conduction plates over the full surface area is ensured. Because of this, the heat generated in the energy storage elements can be better discharged to the respective heat conduction plates and to the cooling assembly and the respective energy storage elements better cooled.

Advantageously it is provided that the clamping device comprises two clamping plates lying against the stack in the stack direction, wherein the clamping plates are clamped to one another through at least one clamping strap and/or by a cover and a base. Appropriately, the clamping plates lie against the respective heat conduction plates closing the stack or the respective energy storage elements closing the stack over a large surface area so that a clamping of the stack by way of the clamping plates is possible in the stack direction. By way of the clamping plates, the clamping force is exerted on the heat conduction plates and the energy storage elements in the stack evenly and over a large surface area so that an undesirable distortion of the heat conduction plate and damage to the energy storage elements that are usually not very elastic is advantageously prevented. Preferably, the clamping plates consist of a plastic material.

The two clamping plates can be clamped to one another for example through the at least one clamping strap. In order to make possible an even clamping, for example rounded edges and support surfaces for the at least one clamping strap can be provided on the two clamping plates. In addition, an undesirable lateral dislocating of the clamping strap on the two clamping plates can thus also be prevented. Alternatively or additionally, the two clamping plates can be clamped to one another by way of the cover and the base. The cover and the base are appropriately arranged along the stack direction and perpendicularly to the two clamping plates located opposite one another. Both on the cover and also on the base, a fixing unit each can be provided on both sides, through which the two clamping plates are fixed to the base and to the cover in a force-fitting or material-bonded manner. The fixing unit can be realised for example in the form of a screw connection or a slot and key connection. The final stack length can also be defined by the fixing units in the base and in the cover.

In order to be able to arrange the energy storage module in the energy storage assembly for the assembly at times it is advantageously provided that the clamping plates each comprise at least one spring engagement heel, through which the respective energy storage module is detachably fixable in a housing. Through the spring engagement heel the energy storage module is detachably and accessibly fixable in the housing so that an assembly on the energy storage module can be performed. Thus, an interconnecting of the respective energy storage module with other energy storage modules or with an external fluidically and/or electrically conductive and/or data-conducting components can take place in particular.

For the durable fixing of the at least one energy storage module in the casing it is provided that the clamping plates each have at least one positive connection lug through which the respective energy storage module is fixable in a force-fitting manner in a casing in a recess that is complementary to the positive connection lug. Through the positive connection lug, the energy storage module can be durably fixed in the casing for example following an interconnecting of the respective energy storage module with other energy storage modules or with an external fluidic and/or electrically conductive and/or data-conducting component.

In the advantageous configuration of the cooling assembly it is provided that the cooling assembly comprises at least one manifold tube arranged in the stack direction, into which the at least one cooling tube opens and that an inlet connector and an outlet connector are fixed to at least one manifold tube in a fluid-conducting manner. Preferably, the cooling assembly comprises multiple cooling tubes, wherein on each of the cooling tubes one of the heat conduction plates or two heat conduction plates located opposite one another and parallel to one another each are fixed in a material-bonded manner. The respective cooling tubes open on both sides in the common manifold tubes arranged along the stack direction and the inlet connector and the outlet connector on one of the manifold tubes make possible the coolant—such as for example water—flowing through the two manifold tubes and the respective cooling tubes.

In order to space-savingly configure the energy storage assembly it is advantageously provided that longitudinal axes of the inlet connector and of the outlet connector perpendicular to the stack direction and that the inlet connectors and the outlet connectors of two energy storage modules arranged mirror-image relative to one another perpendicularly intersect a common straight line that is perpendicular to the stack direction and to the respective longitudinal axes. In this way, the two adjacent energy storage modules can be space-savingly arranged in the energy storage assembly and because of this the energy storage assembly also designed in a compact manner.

Altogether, the cooling of the heat conduction plates and consequently of the respective energy storage elements arranged in the receiving pockets between the heat conduction plates can be improved through the material-bonded fixing of the respective heat conduction plate on the at least one cooling tube of the cooling assembly. In addition, the energy storage assembly according to the invention has a lower stiffness compared with conventional energy storage assemblies, so that upon a heat expansion of the energy storage elements and of the heat conduction plates irreparable damage to the energy storage module is prevented. Furthermore, the energy storage assembly according to the invention has a reduced installation space requirement and can be space-savingly arranged in an electric or hybrid vehicle.

The invention also relates to a method for producing the energy storage assembly described above. Here, the method comprises a shaping of a stack of alternating energy storage elements and heat conduction plates; an arranging of the heat conduction plates perpendicularly on an areal cooling assembly having at least one cooling tube and a material-bonded fixing of the respective heat conduction plates on the at least one cooling tube.

Advantageously it is provided that with the material-bonded fixing the respective heat conduction plates are fixed to the at least one cooling tube by a laser welding. Through the laser welding, the production costs of the energy storage assembly can be advantageously reduced and the respective heat conduction plates fixed to the at least one cooling tube in an expenditure-reduced manner.

So as not to damage the energy storage elements in particular during the laser welding it is advantageously provided that before or after the shaping of the stack a stop offset facing the cooling assembly is formed on the respective heat conduction plates and that during the arranging of the heat conduction plates on the cooling assembly, the stop offset is arranged lying against the at least one cooling tube. By way of the stop offset, an impinging of the laser beam on the respective energy storage element and damaging of the respective storage element can be avoided during the laser welding. In addition, the shaped stack can be position-securely arranged on the at least one cooling tube of the cooling assembly and fixed in a material-bonded manner, as a result of which the manufacturing tolerances can be advantageously minimised.

In order to secure the durable lying of the heat conduction plates against the respective energy storage elements it is provided that prior to the arranging of the heat conduction plates on the cooling assembly the stack is clamped at times through two clamping plates lying against the stack in the stack direction by means of a clamping device. Through the clamping device, the stack is consequently reduced to a defined stack length, so that the heat conduction plates can be position-securely fixed to the at least one cooling tube of the cooling assembly. Furthermore it is provided that after the material-bonded fixing of the respective heat conduction plates the stack is clamped by at least one clamping strap and/or by a cover and a base and that following the clamping of the stack with the at least one clamping strap and/or with the cover and the base, the clamping device is detached from the stack.

Altogether, the energy storage assembly can be produced in an expenditure-reduced and cost-saving manner.

Further important features and advantages of the invention are obtained from the subclaims, from the drawings and from the associated figure description by way of the drawings.

It is to be understood that the features mentioned above and still to be explained in the following cannot only be used in the respective combination stated but also in other combinations or by themselves without leaving the scope of the present invention.

Preferred exemplary embodiments of the invention are shown in the drawings and are explained in more detail in the following description, wherein same reference numbers relate to same or similar or functionally same components.

### BRIEF DESCRIPTION OF THE DRAWINGS

It shows, in each case schematically

FIG. 1 a view of an energy storage assembly according to the invention with an energy storage module;

FIG. 2 a view of an energy storage assembly according to the invention with an energy storage module;

FIG. 3 a further view of the energy storage assembly shown in FIG. 2 with an energy storage module;

FIG. 4 a view of an energy storage assembly according to the invention with two energy storage modules arranged in mirror image relative to one another;

FIGS. 5 to 10 individual steps of a method according to the invention for producing the energy storage assembly shown in FIG. 1 with an energy storage module.

### DETAILED DESCRIPTION

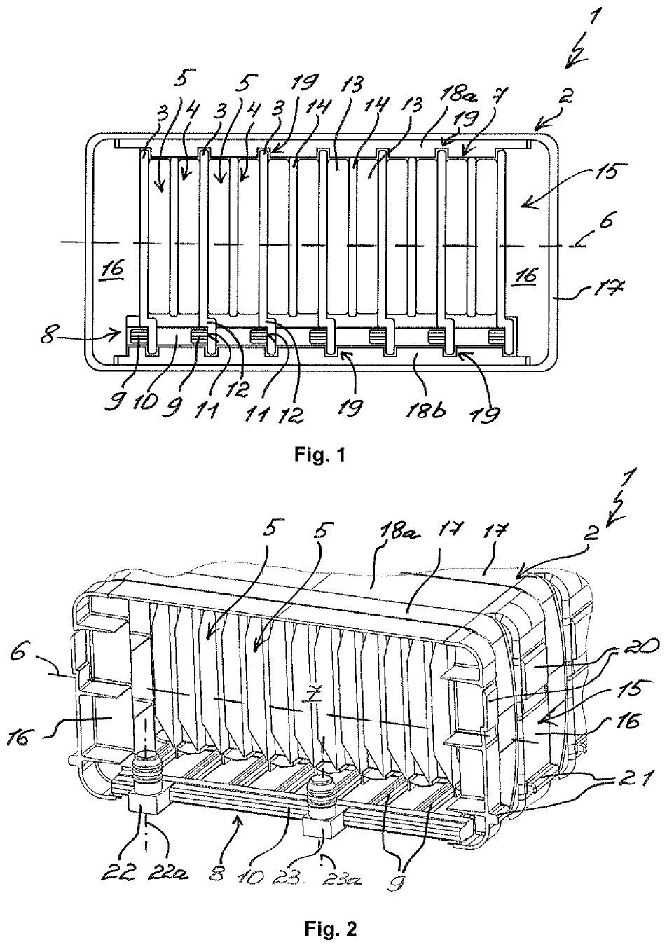

FIG. 1 shows a view of an energy storage assembly 1 according to the invention with an energy storage module 2. The energy storage module 2 comprises multiple heat conduction plates 3 which are arranged parallel to one another. Between the respective two heat conduction plates 3 a receiving pocket 4 is formed, in which an energy storage element 5 each is arranged lying against the respective heat conduction plates 3 on both sides. The alternating heat conduction plates 3 and the energy storage elements 5 are stacked in the stack direction 6 and form a stack 7.

The heat conduction plates 3 are perpendicularly arranged on an areal cooling assembly 8 having multiple cooling tubes 9 through which a coolant can flow, wherein the individual cooling tubes 9 open into a manifold tube 10. The heat conduction plates 3 have a high heat conductivity and can discharge the heat generated in the energy storage elements 5 to the cooling assembly 8. The heat conduction plates 3 are each fixed to a cooling tube 9 in a material placement region 11 in a material-bonded manner—for example through a laser welding. Through the material-bonded fixing of the heat conduction plates 3 on a cooling tube 9 of the cooling assembly 8 each, the cooling of the heat conduction plates 3 and consequently of the energy storage elements 5 arranged in the receiving pockets 4 between the heat conduction plates 3 can be significantly improved.

The heat conduction plates 3 each comprise a stop offset 12 facing the cooling assembly 8, which lies against the respective cooling tube 9. Through the stop offset 12, the heat conduction plates 3 are position-securely fixed to the respective cooling tube 9. In addition, the stop offset 12 can protect the energy storage elements 5 during the material-bonded fixing—in particular during the laser welding—from the laser beam impinging onto the energy storage element 5. The cooling tubes 9 are arranged along the respective heat conduction plate 3 and due to the construction are elastically deformable in the stack direction 6. During a heat expansion of the energy storage elements 5 and of the heat conduction plates 3, irreparable damage in the energy storage module 2 can be advantageously avoided in this manner.

The energy storage elements 5 arranged in the receiving pockets 4 each comprise two energy storage units 13 which are separated from one another by a plate-shaped spring element 14. Each of the energy storage units 13 lies against the heat conduction plate 3 on the one side and against the spring element 14 on the other side. Through the permanently elastic spring element 14, the thermal resistance between the respective energy storage unit 13 and the respective heat conduction plate 3 is significantly reduced and the heat generated in the energy storage units 13 can be better discharged to the heat conduction plate 3. The spring element 14 is fixed in a material-bonded manner—for example through an adhesive coat—on both sides to the energy storage units 13 and the energy storage units 13 to the abutting heat conduction plates 3, so that an undesirable dislocating of the energy storage element 5 in the receiving pocket 4 is prevented.

In addition, the energy storage module 2 comprises a clamping device 15 through which the stack 7 is clamped in the stack direction 6. In the stack 7, the heat conduction plates 3 have a defined distance from one another in this way and the energy storage elements 5 lie against the heat conduction plates 3 over the full surface area. The clamping device 15 comprises two clamping plates 16 which in the stack direction 6 lie against the stack 7 over a large surface area. Through the clamping plates 16, the clamping force is evenly and over a large surface area exerted onto the heat conduction plates 3 and the energy storage elements 5 in the stack 7 and an undesirable distortion of the heat conduction plates 3 and damage to the energy storage elements 5 prevented. In this exemplary embodiment, the clamping plates 16 are clamped to one another through a clamping strap 17 and through a cover 18a and a base 18b. The cover 18a and the base 18b are arranged along the stack direction 6 and perpendicularly to the two clamping plates 16 located opposite one another. Both on the cover 18a and also on the base 18b, multiple fixing units 19 in the form of a slot and key connection each are provided, through which the two clamping plates 16 and the heat conduction plates 3 are positively fixed to the cover 18a and on the base 18b.

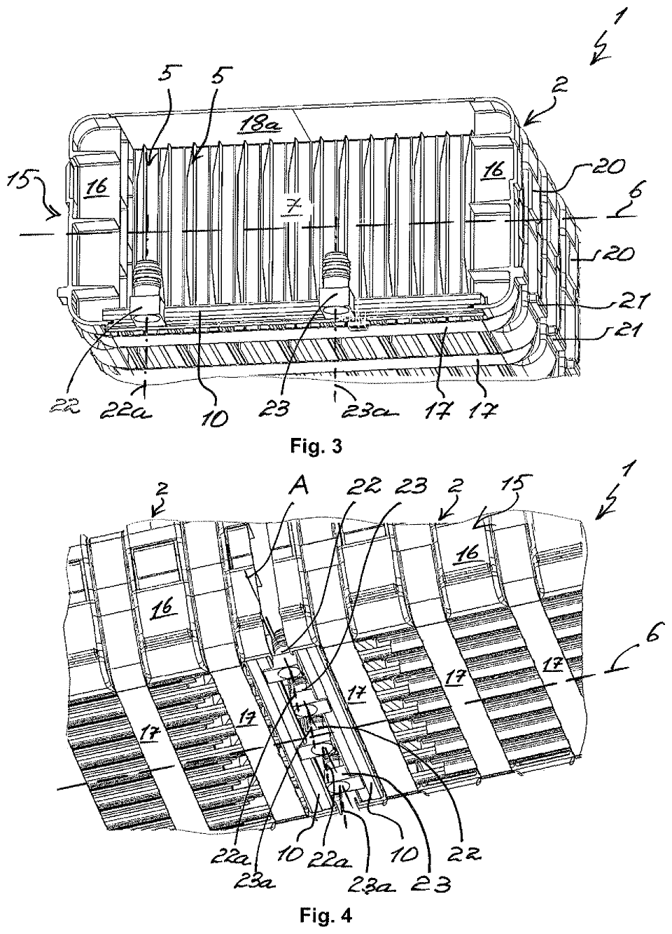

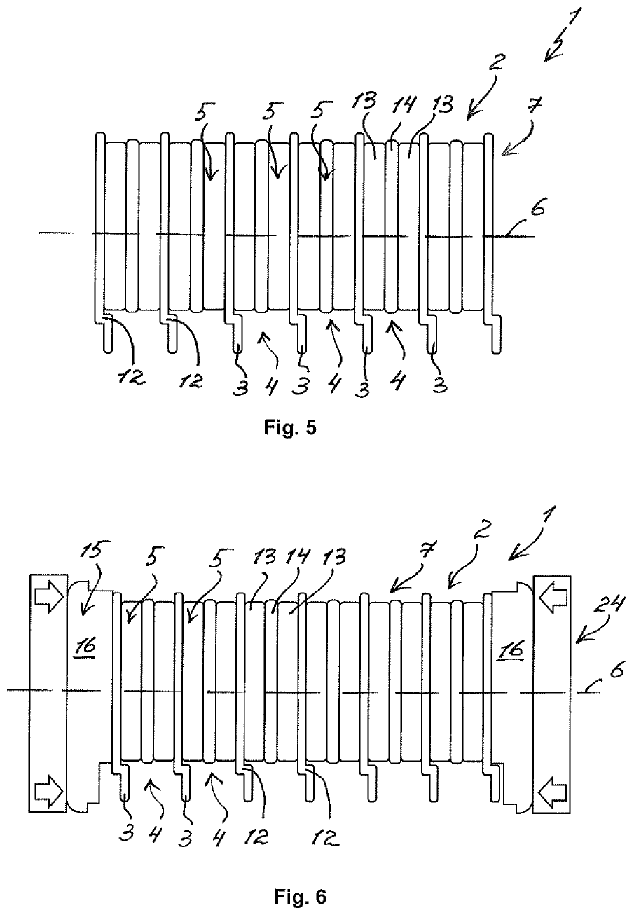

FIG. 2 and FIG. 3 show views of the energy storage assembly 1 according to the invention with the energy storage module 2. Here, the clamping plates 16 comprise multiple spring engagement heels 20, through which the energy storage module 2 is detachably fixable in a housing which is not shown here. By way of the spring engagement heels 20, the energy storage module, for example for interconnecting with an external component, can be detachably and accessibly and consequently, through multiple positive connection lugs 21 integrally formed on the clamping plates 16, permanently fixed in the housing. Through the spring engagement heels 20 and the positive connection lugs 21, the assembly of the energy storage module 2 is clearly simplified. Furthermore, for a coolant to flow through the manifold tube 10 and the cooling tubes 9, an inlet connector 22 and an outlet connector 23 are fixed to the manifold tube 10 in a fluid-conducting manner, wherein a longitudinal axis 22a of the inlet connector 22 and a longitudinal axis 23a of the outlet connector 23 are arranged parallel to one another and perpendicularly to the stack direction 6.

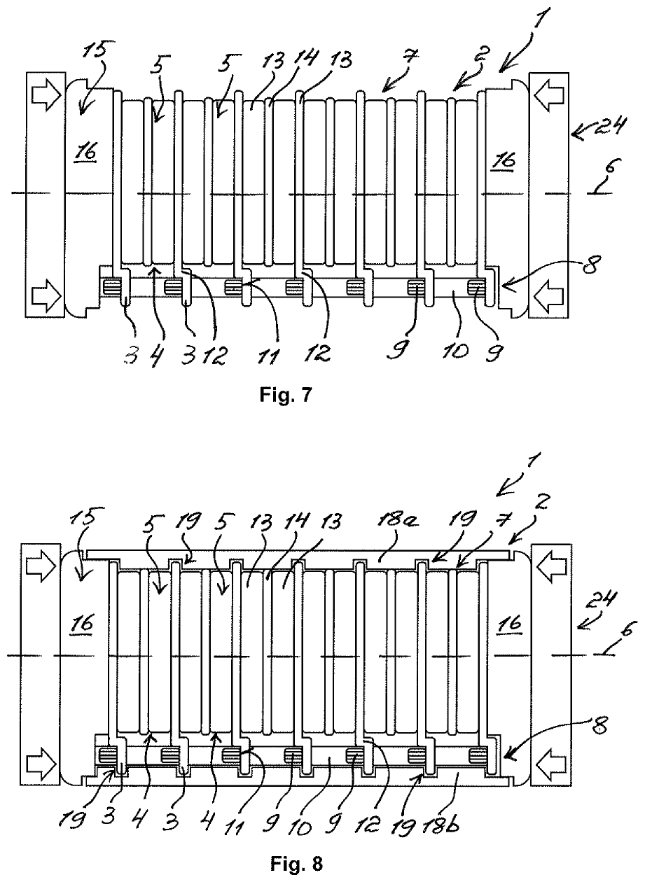

FIG. 4 now shows a view of the energy storage assembly 1 according to the invention with two energy storage modules 2. The two energy storage modules 2 are arranged in mirror image relative to one another, wherein the longitudinal axes 22a of the two inlet connectors 22 and the longitudinal axes 23a of the two outlet connectors 23 perpendicularly intersect a common straight line A that is perpendicular to the stack direction 6 and to the respective longitudinal axes 22a and 23a. In this way, the two adjacent energy storage modules 2 can be space-savingly arranged in the energy storage assembly 1.

Altogether, the cooling of the energy storage elements 5 in the energy storage assembly 1 according to the invention can be significantly improved through the heat conduction plates 3 being fixed to the cooling assembly 8 in a material-bonded manner. In addition, the stack 7 of the energy storage assembly 1 according to the invention has a lower stiffness and an irreparable damage on the energy storage module 2 as a consequence of a heat expansion of the energy storage elements 5 and of the heat conduction plates 3 can be advantageously avoided. Furthermore, the energy storage modules 2 can be space-savingly arranged in the energy storage assembly 1 according to the invention and the installation space requirement for the energy storage assembly 1 according to the invention reduced in an electric or hybrid vehicle.

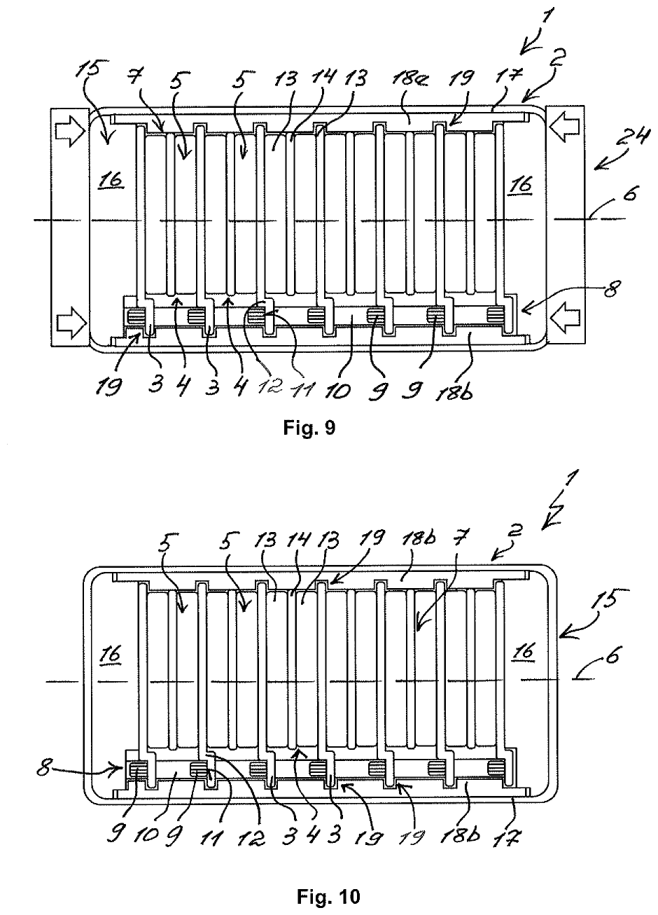

FIG. 5 to FIG. 10 show individual steps of a method according to the invention for producing the energy storage assembly 1 with the energy storage module 2. According to FIG. 1, the energy storage elements 5 are first formed into the stack 7 with a spring element 14 each and with two energy storage elements 13 each alternating with the heat conduction plates 3. According to FIG. 6, the stack 7 is clamped in the clamping direction 6 with two clamping plates 16 by means of a clamping device 24. According to FIG. 7, the clamped stack 7 is fixed to the cooling tubes 9 of the cooling assembly 8 in a material-bonded manner—preferably by way of a laser welding. By way of the stop offsets 12 on the heat conduction plates 3, the energy storage elements 5 are protected from being impinged on by the laser beam during the laser welding. According to FIG. 8, the cover 18a and the base 18b are positively fixed to the stack 7. Following this, the energy storage module is clamped with the at least one clamping strap 17 and according to FIG. 10 the clamping device 24 detached from the energy storage module 2. Through the method according to the invention, the energy storage assembly 1 can be produced in an expenditure-reduced and cost-saving manner.

1. An energy storage assembly comprising at least one energy storage module, wherein:
the at least one energy storage module includes multiple heat conduction plates;
the multiple heat conduction plates are arranged parallel to one another, and a receiving pocket is formed between each set of two adjacent heat conduction plates;
in each receiving pocket, an energy storage element is arranged lying against the receptive heat conduction plates on both sides;
the multiple heat conduction plates are arranged perpendicularly at least on one side on an areal cooling assembly; and
the areal cooling assembly includes at least one cooling tube through which a coolant is flowable and the respective heat conduction plate is fixed to the at least one cooling tube in a material-bonded manner.

2. The energy storage assembly according to claim 1, wherein the respective heat conduction plate is fixed to the at least one cooling tube through a laser welding in the material-bonded manner.

3. The energy storage assembly according to claim 1, wherein a thickness of the respective heat conduction plate corresponds to a thickness of the corresponding cooling tube at least in a material-bonded region.

4. The energy storage assembly according to claim 1, wherein the respective heat conduction plate includes a stop offset facing the areal cooling assembly, which on the associated cooling tube forms a stop for the respective heat conduction plate.

5. The energy storage assembly according to claim 1, wherein each energy storage element includes a plastic casing.

6. The energy storage assembly according to claim 1, wherein the respective heat conduction plate consists of aluminium, an aluminium alloy, graphite, graphene, or a heat-conductive composite material.

7. The energy storage assembly according to claim 1, wherein each energy storage element includes two energy storage units separated from one another by a plate-shaped spring.

8. The energy storage assembly according to claim 7, the plate-shaped spring on both sides has a bonding layer each, through which the plate-shaped spring is fixed to both sides to the respective energy storage units in a material-bonded manner.

9. The energy storage assembly according to claim 7, wherein the energy storage element includes at least one electrically insulating coating, which is arranged between the respective heat conduction plate and the respective energy storage unit.

10. The energy storage assembly according to claim 9, wherein the electrically insulating coating comprises a bonding layer each on both sides, through which the electrically insulating coating is fixed to the respective energy storage unit and to the respective heat conduction plate in a material-bonded manner.

11. The energy storage assembly according to claim 1, wherein at least one of the at least one energy storage module includes a clamp, through which a stack formed through the heat conduction plates and the energy storage elements is clamped in a stack direction.

12. The energy storage assembly according to claim 11, wherein the clamp includes two clamping plates lying against the stack in the stack direction, wherein the clamping plates are clamped to one another at least one of (i) through at least one clamping strap, and (ii) through a cover and a base.

13. The energy storage assembly according to claim 12, wherein the clamping plates each has at least one spring engagement heel, through which the respective energy storage module is detachably fixable in a housing.

14. The energy storage assembly according to claim 12, wherein the clamping plates each includes at least one positive connection lug, through which the respective energy storage module is fixable in a force-fitting manner in a housing in a recess that is complementary to the positive connection lug.

15. The energy storage assembly according to claim 1, wherein the areal cooling assembly includes at least one manifold tube arranged in a stack direction, in which the at least one cooling tube opens, and wherein an inlet connector and an outlet connector are fixed to at least one manifold tube in a fluid-conducting manner.

16. The energy storage assembly according to claim 15, wherein longitudinal axes of the inlet connector and of the outlet connector are perpendicular to the stack direction, and and wherein the inlet connectors and the outlet connectors of two energy storage modules arranged in mirror image relative to one another perpendicularly intersect a common straight line that is perpendicular to the stack direction and to the respective longitudinal axes.

17. A method for producing an energy storage assembly, comprising:
shaping a stack consisting of alternating energy storage elements and heat conduction plates, where the heat conduction plates are arranged parallel to one another with a receiving pocket formed between each set of two adjacent heat conduction plates, one of the energy storage elements being arranged in each receiving pocket lying against the respective heat conduction plates on both sides;
arranging the heat conduction plates perpendicularly on an areal cooling assembly having at least one cooling tube through which a coolant is flowable; and
fixing the respective heat conduction plates on the at least one cooling tube in a material-bonded manner.

18. The method according to claim 17, wherein during the material-bonded fixing, the respective heat conduction plates are fixed to the at least one cooling tube through a laser welding.

19. The method according to claim 17, wherein before or after the shaping of the stack, on the respective heat conduction plates a stop offset facing the cooling assembly is formed, and during the arranging of the heat conduction plates on the areal cooling assembly, the stop offset is arranged lying against the at least one cooling tube.

20. The method according to claim 17, wherein before the arranging of the heat conduction plates, on the cooling assembly the stack is clamped at times through two clamping plates lying against the stack in a stack direction via a clamp.

21. The method according to claim 20, wherein after the material-bonded fixing of the respective heat conduction plates, the stack is clamped at least one of (i) through at least one clamping strap and, and (ii) through a cover and a base, and wherein after the clamping of the stack with the at least one of (i) the at least one clamping strap, and (ii) the cover and the base, the clamp is detached from the stack.
